(19) United States
(12) Patent Application Publication
(10) Pub. No.: US 2017/0021790 A1
(43) Pub. Date: Jan. 26, 2017

(54) LED Crush Sensor

(71) Applicant: Autoliv ASP, Inc., Ogden, UT (US)

(72) Inventor: James M. Young, Brighton, MI (US)

(73) Assignee: Autoliv ASP, Inc.

(21) Appl. No.: 14/806,109

(22) Filed: Jul. 22, 2015

(51) Int. Cl. B60R 21/0136; G01B 11/16; B62D 21/15; B60R 21/015; B60N 2/00

(52) U.S. Cl. CPC B60R 21/0136; B60R 21/0152; B60N 2/00; B62D 21/152; G01B 11/16; B60R 2021/01013

(57) ABSTRACT

A sensor assembly for detecting crush of a compliant material. The sensor assembly includes a light source such as an LED, and a light sensor. In one implementation, the sensor assembly is used for detecting and impact of a motor vehicle with an external object or structure. Crush of the energy absorbing material, which may be provided in the form of an open or closed cell type polymeric foam is detected through a change in the intensity of the reflected back light received by the light sensor in response to compression of the energy absorber material. Other applications are contemplated.

### FIELD OF THE INVENTION

This invention relates to a motor vehicle mounted sensor system and, in particular, to one adapted to be integrated into a motor vehicle exterior component for detecting impacts including high energy impacts as well as so-called low-energy impacts such as pedestrian and bicyclists collisions, for use in activating appropriate impact mitigation countermeasures. Further applications can include evaluating the crush of an energy absorbing structure for other purposes; in one example, for evaluating the compression of an automotive seat cushion. The concepts of the present invention may also be utilized to provide electrical switches for various applications.

### BACKGROUND OF THE INVENTION

Motor vehicle collisions with pedestrians and bicyclists are a major concern. While significant advancements have been made in protecting motor vehicle occupants from injury due to impacts, there remain significant opportunities to reduce injuries, particularly head injuries, to pedestrians struck by motor vehicles. Various countermeasure systems have been devised for this purpose and are in use. Hood lifter mechanisms pop the engine compartment hood to an upward displaced position where it can absorb energy as a pedestrian strikes the hood area during an impact. The lifted hood provides energy absorption. Other measures such as external airbags, and impact absorbing vehicle front-end features have further been conceived and implemented. In this description, reference to pedestrian impacts is intended to include other types of impacts including those with bicyclists or animals and other similar low-energy (as compared with striking other vehicles or fixed objects) impacts.

Another category of vehicle impacts are so-called high energy impacts in which a vehicle collides with another vehicle or a fixed object. For these impacts, there is typically an active safety system activated to provide vehicle occupant protection. Systems for frontal impact occupant protection which may be activated including seat belt pretensioners, retractor load limiter activation, and frontal impact airbags. For side impacts, seatbelt pretensioners may also be activated along with inflatable restraint devices such as side curtain airbags and lower torso airbags. As in the case of low energy impacts, reliable detection of a vehicle impact occurrence is necessary to deploy the appropriate responsive systems.

For any active impact countermeasure to be operative, some means of detecting an impact is required. Numerous systems are available for detecting such impacts. One approach used predominantly for sensing low-energy impacts uses an elongated flexible hollow tube which defines an enclosed volume of gas, typically air, positioned at an impact area of the vehicle. Upon an impact, the soft fascia of the vehicle front end is deformed and the sensor tube is compressed, generating a gas pressure pulse in the tube which is sensed by a pressure sensor, thereby detecting the impact. Numerous other sensor technologies may be implemented which measure strain or compression exerted by deformation of the vehicle front end fascia. For example, other types of impact sensing systems include switch arrays, peizo cable, fiber optic, etc.

While low-energy impact systems are typically associated with an exterior vehicle components such as a front bumper fascia or flexible body-side molding element, one type of high-energy impact sensors is inertially sensitive types mounted to a vehicle body component and protected from direct deformation during an impact. Other types of high-energy impacts sensor may be mounted to a vehicle structural component such as a side-impact door beam, frame rail, cross body bumper beam, or other component. A suite of sensors is typically used to provide signals to a dedicated electronic control unit (ECU) which controls safety systems.

There is a constant desire by automotive manufacturers and their suppliers to provide high-performance impacts sensors which may be provided at a low cost, with high degrees of reliability. Although numerous sensor types are available such as those described previously, there is a continuing need for improvements in such systems. Desirable features in addition to low-cost and reliability include adaptability to different vehicle design configurations, ease of assembly, and reliable service operation.

In view of the aforementioned considerations, there is a need in the art for improved vehicle impact system which addresses the previously mentioned shortcomings in prior art systems. In particular, the need exists to enable flexibility in adjusting the sensitivity or tuning of a compressive sensor, and which is highly adaptable, and provides repeatable characteristics.

In addition to the foregoing applications there are numerous other applications in automotive component design and in other fields where it is desirable to measure the deformation or crush of a compliant element for some desired effect.

In any volume produced automotive application, cost concerns are significant. The increased sophistication and capabilities of motor vehicles must be provided in an efficient and low cost manner in order that the features are commercially viable. Accordingly, systems provided to meet the design objectives mentioned above need to be manufacturable and capable of being produced and assembled in a cost effective manner.

### SUMMARY OF THE INVENTION

In accordance with the present invention, a compressive sensor system is provided in the form of a light source such as a light emitting diode (LED) which emits light into a volume of a compliant material such as a flexible cellular foam material with a photodetector positioned adjacent to the light source. Compression of the compliant material causes a change in the intensity of the reflected or scattered light signal from the light source, thus providing an indication of the degree of compression of the material. Such compression may be caused by an external impact which may be a low or high energy type. In one embodiment of the invention, the sensor system is incorporated into a front bumper structure of a motor vehicle. Other implementations may include use for side-impact, rear impact, or for other sensing applications.

In another application of the present invention in connection with motor vehicle systems, the crush sensor may be implemented in a motor vehicle seat cushion formed of a compliant elastomeric foam or foam-like material and used to measure the compression or deformation of the seat cushion. This can be used as part of a system to sense the presence of an occupant or a child restraint system in a seat, or detect seated occupant characteristics. Numerous other applications of the present invention are envisioned including use as an electrical switch for various applications.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF THE DRAWINGS

FIG. 1 is a front pictorial view of a motor vehicle incorporating an LED crush sensor system in accordance with this invention;

FIG. 2 is overhead schematic drawing of the a vehicle front end incorporating an LED crush sensor in accordance with this invention taken along line 2-2 from FIG. 1;

FIG. 3 is a side cross-sectional view through the front fascia region of a motor vehicle taken along line 3-3 from FIG. 1;

FIG. 4 is a pictorial view of an LED crush sensor in accordance with this invention;

FIG. 5 is a cross-sectional view similar to FIG. 2 through an LED crush sensor incorporated into a vehicle in accordance with an embodiment of the invention, shown in a normal condition;

FIG. 6 is a cross-sectional view similar to FIG. 2 through an LED crush sensor incorporated into a vehicle in accordance with an embodiment of the invention, shown in a compressed condition;

FIG. 7 is a pictorial view of a motor vehicle seat having a seat cushion incorporating an LED crush sensor in accordance with the present invention; and

FIG. 8 is a cross-sectional view through an LED crush sensor in accordance with this invention implemented as a switching or sensing device.

### DETAILED DESCRIPTION OF THE INVENTION

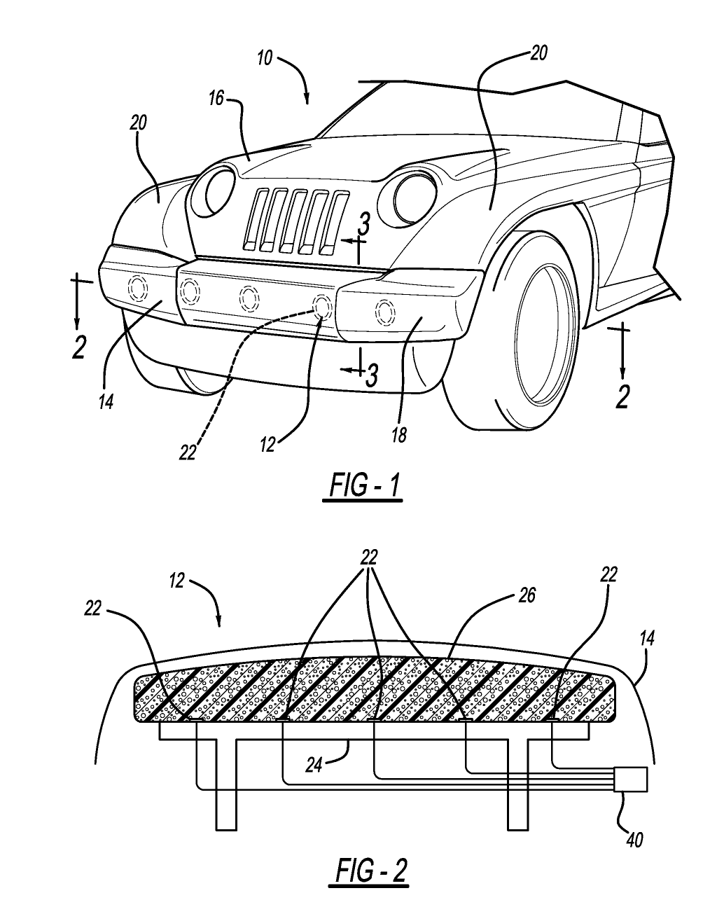

With reference to FIG. 1, a representative motor vehicle 10 is shown with its front end 12 which includes front fascia 14, hood 16, and bumper 18, and blends with the vehicle front fenders 20. In one implementation of the present invention, LED crush sensor assembly 22 is positioned in a lower portion of front end 12, behind front fascia 14 or over bumper 18. Sensor 22 is optimally placed behind a motor vehicle component at a position such that it that receives the best or first contact with an object during an impact and also high in terms of integration of the components. In the illustrated embodiment, sensor 22 is mounted behind front fascia 14, but is shown in FIG. 1 in broken lines to show its positioning in an exemplary implementation. In a preferred implementation of the present invention, a plurality of the LED crush sensors 22 would be provided, such as the array of sensors positioned at intervals distributed laterally across the vehicle front end as illustrated by phantom lines in FIG. 1.

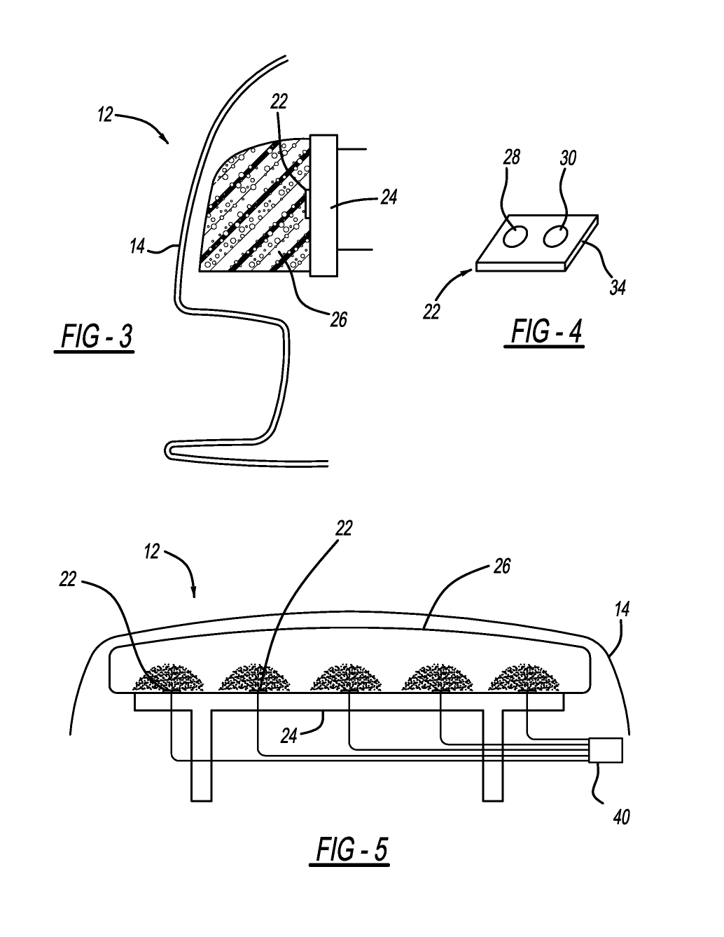

FIG. 2 is an overhead view of the principal components of vehicle front end 12. As shown, cross body bumper beam 24 is shown with compliant material in the form of energy absorbing structure 26 with a plurality of the LED crush sensors 22 sandwiched between the bumper beam and the energy absorbing structure. Front fascia 14 covers the face of energy absorbing structure 26. FIG. 3 provides another view of the internal components of front end 12.

Energy absorber structure 26 or other components formed of a compliant material may be provided in various configurations such as formed of an open or closed cell type polymer foam material. Polyurethane (PU) foam materials are frequently use for these applications. Open cell type foam materials are believed most suitable for use in connection with the present invention. Semi-rigid types such as Styrofoam may also be used as a compliant material with this invention. Gel type materials perhaps having interspersed reflective particle additives may also be used to provide the effect of the present invention.

Now with reference to FIG. 4, a more detailed illustration of LED crush sensor 22 is provided. As shown, sensor 22 includes LED light source 28. Although an LED type light source is preferred, other types of light sources preferably emitting visible light may be used in alternate implementations of the present invention. Adjacent to light source 28 is light sensor 30 which may be in the form of a photodetector or other light intensity receptive sensor. Light source 28 and light sensor 30 are preferably incorporated into a housing 34, thus defining a sensor assembly 22.

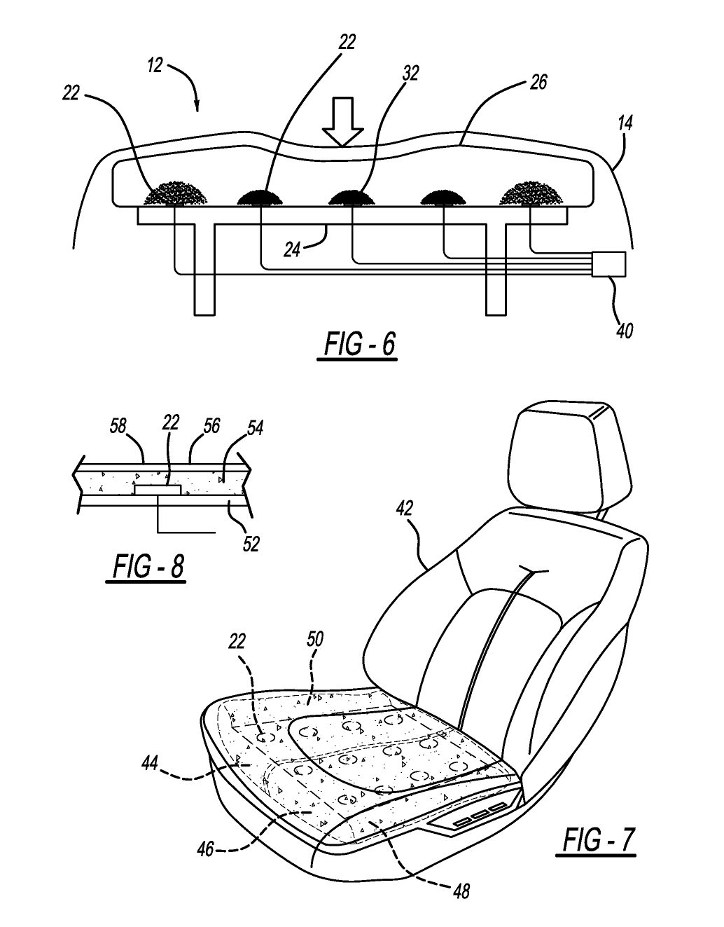

FIG. 5 illustrates the normal condition of the components in which energy absorbing structure 26 is in its normal uncompressed state and is positioned behind front fascia 14 with sensor assembly 22, sandwiched between the energy absorbing structure and cross body beam 24. To improve clarity, FIGS. 5 and 6 do not show crosshatching indicating the foam material of energy absorbing structure 26. In the condition shown by FIG. 5, light emitted by LED 28 creates a light “halo” 32. Although halo 32 is shown as a discrete volume, in fact it represents a bubble shaped generally hemispherical volume of diminishing light intensity as the light from LED 28 is attenuated as it is transmitted into energy absorbing structure 26. Thus, for use with the present invention, the compliant material or energy absorbing structure 26 is made from a material which is partially transmissive and reflective of light emitted by LED 28. Foam materials for energy absorbing structure 26 have internal voids which create surfaces which may act as light reflectors. The reflected back signal is received by light sensor 30.

FIG. 6 illustrates a compressed condition in which an external force acting against front fascia 14 compresses energy absorbing structure 26. This compression results in compression of halo 32 which increases the intensity of light measured by light sensor 30, thus indicating a crushed, compressed, or an impact condition. In the crushed condition, light transmitted into the compliant material is internally reflected more strongly and returned to light sensor 30 than when the material in a normal uncompressed (or less compressed) state, which increases the intensity acting on the light sensor. Such a greater reflection can be caused by the multiplicity of internal surfaces creating the voids within structure 26 which are compressed and forced into closer proximity to LED 28 and light sensor 30.

In an exemplary implementation of the present invention an electronic control unit (ECU) 40 is provided which provides a driver circuit for providing power to LED 28. Preferably some regulation of supply electrical current is provided to regulate the intensity of light emitted by LED 28. ECU 40 is also configured to detect the signal level from light sensor 30. An initializing of the responsiveness of sensor assembly 28 could be provided in which, upon powering up the vehicle, a routine is undertaken in which a signal representing the signal intensity from light sensor 30 is processed by ECU 40 and saved. An assumption is made that at such an initial condition, energy absorbing structure 26 is not compressed due to crush or impact. Energy absorbing structure 26 may however be maintained in a partially compressed state (as compared with its “free” state when it is separated from other components). A difference in the intensity of light detected by light sensor 30 is used to detect the occurrence of compression or crushing as may occur in an impact.

As compared with prior art sensors utilizing a light source, LED crush sensor 22 is preferably implemented such that LED 28 and light sensor 30 are positioned closely or compressed against the compliant material forming energy absorbing structure 26. The system relies upon energy absorbing structure 26 (or another component of a compliant material) becoming more internally reflective when crushed or compressed. Accordingly, some of the light reflected back to the light sensor 30 is from portions of the energy absorbing structure deep inside the compliant material body. This is distinguishable from systems which essentially measure the distance between the sensor assembly and a movable or deformable surface based on a change in the reflected light measured by a photodetector.

FIGS. 1 and 2 illustrate that an array of LED crush sensors 22 may be implemented, located strategically around the perimeter of the vehicle. While LED crush sensor 22 is described and illustrated as implemented for frontal impact detection, the sensor may be implemented in other ways at alternate locations on the vehicle 10, or in other applications will. For example, crush sensors 22 may be provided at locations at the rear bumper fascia of the vehicle. Further implementations could include side-impact detection where sensors 22 are integrated into body side molding components.

Throughout this description reference is made to energy absorbing structure 26 and measuring crush of such structure. Energy absorbing structure 26 is further described here more broadly as formed of a compliant material. Moreover, sensing of crush of the compliant material is regarded as equivalent to measuring its compression, and therefore LED crush sensor 22 is more generically a compression or compressive sensor.

FIG. 7 illustrates another implementation of LED crush sensor 22 in accordance with this invention. Since the system essentially measures compression of a compliant element such as a foam-like material, applications beyond impact detection may also be exploited. For example in FIG. 7, crush sensor 22 is implemented to measure the extent of compression of seat cushion 44 of vehicle occupant seat 42. Seat cushion 44 is formed with a structural lower seat pan 46 typically made of sheet metal, a cushion pad 48 formed of a compliant foam-like material, and covered by seat trim 50. Crush sensor 22 can be used to detect the presence of an occupant in seat 42 or evaluate the weight of an occupant, perhaps as part of an occupant classification system which is used in prior art systems to tailor deployment of active safety systems based upon occupant characteristics. In addition, by using a suitable distributed array of LED crush sensors 22 mounted onto seat pan 46, the compression characteristics associated with an installed child restraint seat can be detected, very useful in deactivating deployable safety systems at the seat location where a child seat is present.

Further embodiments and applications of sensor assembly 22 are also envisioned such as using the system as a switch in which an operator compresses compliant material such as an elastomeric foam covering sensor assembly 22 to activate some vehicle (or other) system for any applications were actively controlled switches are found. An example of such an embodiment is illustrated by FIG. 8, in which LED crush sensor 22 is mounted to structural support panel 52, and covered by a sheet of compliant material 54, and by exposed trim layer 56 (so-called “self-skinning” foam materials could avoid the requirement of a discrete trim layer). A force applied to region 58 overlying crush sensor 22 will provide a responsive electrical signal. This change in the degree of compression may be actively controlled to provide a switch effect as mentioned above, or can be used in other application where the state of compression of compliant material 54 can provide useful information.

While the above description constitutes the preferred embodiment of the present invention, it will be appreciated that the invention is susceptible to modification, variation, and change without departing from the proper scope and fair meaning of the accompanying claims.

1. A crush sensor assembly for detecting compression of a compliant material, comprising:
a light source generating light interacting with the compliant material, the compliant material of the type being partially transmissive and partially reflective of the light, and
a light sensor positioned adjacent to the light source such that the sensor receives light produced by the light sensor which is reflected back to the light sensor from within the volume of the compliant material, and upon deformation of the compliant material, the intensity of the light received by the light sensor changes, thereby providing an indication of the compression of the compliant material.

2. The crush sensor assembly according to claim 1, wherein the light source and the light sensor are integrated into a sensor assembly.

3. The crush sensor assembly according to claim 1, wherein the compliant material is in the form of a polymeric foam material.

4. The crush sensor assembly according to claim 1, further comprising a controller for receiving a signal from the light sensor and for detecting a change in the intensity of light received by the light sensor for detecting the compression of the compliant material.

5. The crush sensor assembly according to claim 1, wherein the compliant material is formed of a polymeric material which is one of a closed cell foam, an open cell foam, and a gel.

6. The crush sensor assembly according to claim 1, wherein the light sensor is placed in contact with the compliant material both in a normal condition and a compressed condition.

7. The crush sensor assembly according to claim 1, further comprising wherein the crush sensor assembly is implemented as an impact detection sensor for mounting to a motor vehicle component and wherein the compliant material is provided in the form of an energy absorbing structure.

8. The crush sensor assembly according to claim 7, further comprising a vehicle component in the form of a cross body bumper beam with the sensor assembly positioned between the energy absorbing structure and the beam.

9. The crush sensor assembly according to claim claim 7, further comprising a front fascia covering the energy absorbing structure.

10. The crush sensor assembly according to claim claim 7, further comprising a plurality of the crush sensor assemblies arranged on a motor vehicle component.

11. The crush sensor assembly according to claim claim 7, wherein the motor vehicle component is in the form of the vehicle front end.

12. The crush sensor assembly according to claim 1, wherein the crush sensor assembly is implemented in a motor vehicle seat cushion structure for detecting compression of the seat cushion.

13. The crush sensor assembly according to claim 12, further comprising a plurality of the crush sensor assemblies mounted to a support structure within the seat cushion, and having a seat pad formed of the compliant material overlying the support structure.

14. The crush sensor assembly according to claim 1, wherein the crush sensor assembly is implemented as an electrical switch providing a changing electrical signal in response to compression of the compliant material.

15. The crush sensor assembly according to claim 1, further comprising:
the compliant material in the form of a foam-type elastomeric material,
a housing, to which the light source and the light sensor are mounted.

16. The crush sensor assembly according to claim 15, further comprising a controller for receiving a signal from the light sensor and for detecting a change in the intensity of light received by the light sensor for detecting compression of the compliant material.

17. The crush sensor assembly according to claim 15, wherein the light sensor is placed in contact with the compliant material both in a normal condition and a compressed condition.

18. The crush sensor assembly according to claim 15, further comprising wherein the crush sensor assembly is implemented as an impact detection sensor for mounting to a motor vehicle component and wherein the compliant material is provided in the form of an energy absorbing structure.

19. The crush sensor assembly according to claim 15, further comprising a vehicle structural element in the form of a cross body bumper beam with the sensor assembly positioned between the compliant material and the beam.

20. The crush sensor assembly according to claim claim 15, further comprising a plurality of the crush sensor assemblies arranged on a motor vehicle component.
